(19) United States
(12) Patent Application Publication
(10) Pub. No.: US 2010/0076865 A1
(43) Pub. Date: Mar. 25, 2010

(54) Method and system for personalizing portable electronic devices

(75) Inventors: Jonathan Kaplan, San Francisco, CA (US); Ariel Braunstein, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Pure Digital Technologies, Inc., San Francisco, CA (US)

(21) Appl. No.: 12/284,262

(22) Filed: Sep. 19, 2008

(51) Int. Cl. G06Q 30/00; G06Q 50/00; G06F 3/048

(52) U.S. Cl. 705/27; 705/26; 715/815

(57) ABSTRACT

A method and system for personalizing a portable electronic device and a personalized portable electronic device. The method of personalizing a portable electronic device comprises determining a customized graphics image based on input from a user. In some cases the user can create the customized graphics image using a design generator having a random generator. The method also provides for having the customized graphics image permanently affixed to the portable electronic device. In some cases, the method also allows the user to share their customized graphics image with other users.

### CROSS-REFERENCES TO RELATED APPLICATIONS

The following three U.S. patent applications (including this one) are being filed concurrently and the entire disclosures of the other applications are hereby incorporated by reference into this application for all purposes:
U.S. patent application Ser. No. ______, filed Sep. 19, 2008, entitled “Method and System for Personalizing Portable Electronic Devices” (Attorney Docket No. 027643-002100US); and
U.S. patent application Ser. No. ______, filed Sep. 19, 2008, entitled “Design Generator for Personalization of Electronic Devices” (Attorney Docket No. 027643-002200US); and
U.S. patent application Ser. No. ______, filed Sep. 19, 2008, entitled “Method of Operating a Design Generator for Personalization of Electronic Devices” (Attorney Docket No. 027643-002300US).

### BACKGROUND OF THE INVENTION

Portable electronic devices have become part of our everyday life due, in part, to their rapidly dropping prices and widespread availability. A portable electronic device refers to any device with electronics such as a video camera, a video recorder, a camcorder, a digital camera, a cellular phone, a personal digital assistant (PDA), laptop computer, or the like.

Portable electronic devices have become an expression of our personal style. As an example, walk down any city street and you may hear a variety of personal ring tones coming from cell phones. Not only are users able to download files such as ring tones to their portable electronic devices, software packaged with the portable electronic devices typically allow users to customize backgrounds and menus. These customizations are not however visible when the device is powered down. Further, these customizations are internal to the device and do not change the appearance of the device casing.

Some previous systems customize a separate part from the portable electronic device and attach it over the portable electronic device to change the external appearance of the device. For example, one previous system provides a changeable faceplate for a PDA that can be printed with photographic images from the user. This faceplate snaps over the PDA and can be removed and replaced with another faceplate if desired. Another previous system provides a changeable silicone skin available in various predefined colors to fit over the device. Again, these skins are a separate part from the device. Another previous system provides a removable decal that adheres to the back of a mobile phone. These decals can include images provided by the user. Similar to the changeable faceplates and skins, these decals are separate from the portable electronic device and can be removed by the user.

### SUMMARY OF THE INVENTION

Embodiments of the disclosure relate to methods and systems for personalizing portable electronic devices, and personalized portable electronic devices created with these methods and systems.

One embodiment of the disclosure is directed to a method of personalizing a portable electronic device comprising determining a customized graphics image based on user input and providing for permanently affixing the graphics image to the portable electronic device. In some cases, the customized graphics image is permanently affixed to a sealed housing of the portable electronic device.

Another embodiment of the disclosure is directed to a system for personalizing a portable electronic device comprising a client computer and a server computer in communication with the client computer. The server computer has a computer readable medium having code for determining a customized graphics image based on user input entered on the client computer and code for providing for permanently affixing the customized graphics image to the portable electronic device.

Another embodiment of the disclosure is directed to a personalized portable electronic device comprising a processor, a rechargeable power supply communicating with the processor, a memory communicating with the processor, and a housing having an outer shell. The housing is sealed around the processor, rechargeable power supply and the memory. A customized graphics image determined by a user is permanently affixed to the outer shell after the housing is sealed.

Another embodiment of the disclosure is directed to a method of personalizing a finished portable electronic device comprising generating a customized graphics image using a design generator based on user input and providing for permanently affixing the customized graphics image on a sealed housing of the finished portable electronic device.

Another embodiment of the disclosure is directed to a method of personalizing a finished portable electronic device comprising determining a customized graphics image based on user input and permanently affixing the customized graphics image to the finished portable electronic device.

Another embodiment of the disclosure is directed to a method of personalizing a finished portable electronic device. The method provides an option of using a design generator to determine a customized graphics image. If the user selects the option of using the design generator, the method also determines the customized graphics image using the design generator based on input from the user. The method also sends the customized graphics image to a printer. The printer permanently affixes the customized graphics image onto the finished portable electronic device.

These and other embodiments of the disclosure are described in further detail below.

### BRIEF DESCRIPTION OF THE DRAWINGS

FIG. 1 is a block diagram of an exemplary system for personalizing portable electronic devices, in accordance with an embodiment of the disclosure.

FIG. 2 is a flowchart illustrating an exemplary method of personalizing electronic devices, in accordance with an embodiment of the disclosure.

FIGS. 3-6 are screen shots of web pages of an exemplary design site, in accordance with embodiments of the disclosure.

### DETAILED DESCRIPTION OF THE INVENTION

Embodiments of the disclosure are directed to methods and systems for personalizing portable electronic devices. Generally, a user accesses a design site (e.g., a website comprising a plurality of webpages) that allows the user to create a personalized portable electronic device. The user enters colors into a design generator on the design site. The user may also enter other parameters or information into the design generator. The design generator creates a series of graphics images using a random generator based on the user-defined parameters and animates the graphics images on a display. The user selects a snapshot image of this animation and orders a portable electronic device personalized with this graphics image. Alternatively, the user can upload an image and order a portable electronic device personalized with the uploaded image or select from stock images. According to some embodiments, the images can be modified by the user after uploading or selection. The order is sent to a printer which affixes the graphics image onto a finished portable electronic device and the personalized portable electronic device is shipped to the user. The user can choose to share their graphics image with other users or get a portion of the profits from the sale of products with the graphics image that they created.

Certain embodiments of the disclosure provide one or more advantages. One advantage may be that the user can personalize their portable electronic device to be an expression of their personal style, creativity, and passion. The user is no longer restricted to customizing the content within the portable electronic device. Now, the user can permanently change the outer appearance of their portable electronic device. Also, an advantage may be that the user is given the tools to create an original graphics image. For example, the user can use a design generator to create new images with a random generator. Another advantage may that the user can share their unique image with others or earn part of the profits from products sold with their image. In this way, the user has a new avenue for displaying their talents and creativity to others with the potential of earning profits as well.

Certain embodiments of the disclosure may include none, some, or all of the above advantages. One or more other advantages may be readily apparent to one skilled in the art from the figures, descriptions, and claims included herein.

### I. System for Personalizing Portable Electronic Devices

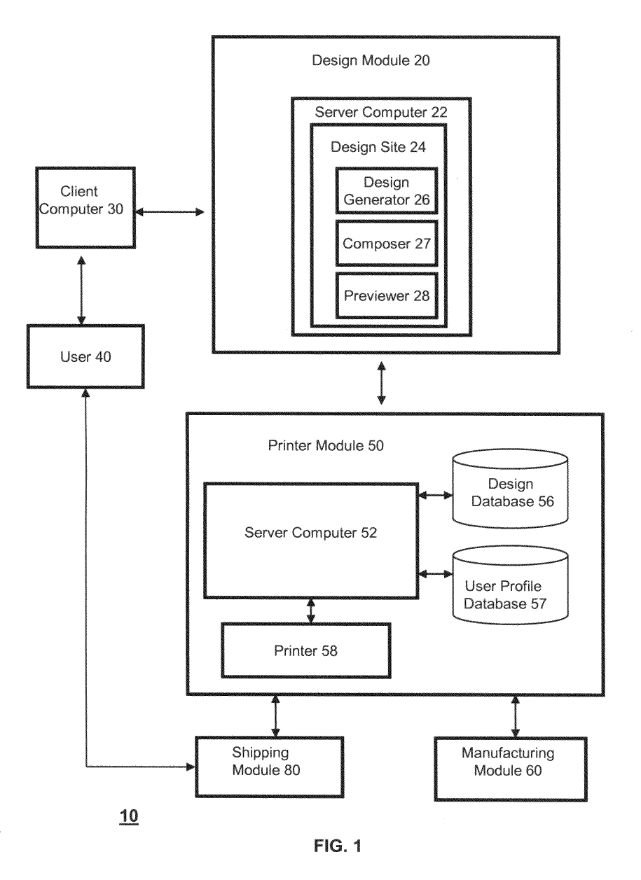

FIG. 1 is a block diagram of an exemplary system 10 for personalizing portable electronic devices, in accordance with an embodiment of the disclosure. System 10 includes a design module 20 having a server computer 22 with a design site 24. Design site 24 allows the user 40 to select a graphics image and place an order for a portable electronic device personalized with the selected image. Design site 24 comprises a design generator 26, composer 27, and previewer 28. System 10 also comprises a client computer 30 and a user 40. User 40 operates client computer 30 to access design site 24 on a web browser displayed on client computer 30. Although one user 40 and one computer 30 are shown in the illustrated embodiment, it will be appreciated that the present disclosure contemplates that a large number of users will access design site 24.

System 10 also includes a printer module 50 for fulfilling the order for a personalized portable electronic device and a manufacturing module 60 for providing a finished portable electronic device. A finished portable electronic device refers to a portable electronic device that is an assembled product that would otherwise be ready for delivery to a customer except that it has not been personalized as described below. Printer module 50 is in communication with design module 20 to receive the order for the personalized portable electronic device and to send any communications regarding the fulfillment of the order. Printer module 50 is in communication with manufacturing module 60 to receive a finished portable electronic device. Printer module 50 also has a printer 58 for affixing the graphics image on the portable electronic device. Printer 58 is in communication with server computer 52 to receive the graphics image. Printer module 50 also has a design database 56 for storing/retrieving graphics images and a user profile database 57 for storing/retrieving information about the user 40.

System 10 also includes a shipping module 80 in communication with the printer module 50 and the user 40. Shipping module 80 receives the personalized portable electronic device from the printer module 50 and ships it to the user 40. Shipping module 80 can also receive a portable electronic device from user 40 for permanently affixing a graphics image and shipping back to user 40.

A portable electronic device refers broadly to any suitable device having electronics. Some examples of suitable devices include a video camera, a video recorder, a camcorder, a digital camera, a cellular phone, a personal digital assistant (PDA), a laptop computer, or the like. A personalized portable electronic device refers to a portable electronic device that is personalized with a graphics image chosen or created by the user. A graphics image refers to any suitable visual representation (e.g., drawing, painting, or photograph). Although the graphics image does not include text, some embodiments of this disclosure may personalize the portable electronic device with text along with the graphics image. The graphics image can be an image selected from a library of pre-defined or stock images shown on design site 24. Alternatively, the graphics image can be a customized graphics image created by user 40 on design site 24 or uploaded by user 40 from computer 30. A customized graphics image refers to a graphics image customized by user 40.

The portable electronic device comprises any suitable electronic or structural element. Some examples of suitable electronic elements include a processor for performing the operations of the portable electronic device, a computer readable medium for storing data (e.g., video files), a power supply for providing power to the processor (e.g., a rechargeable battery), a display, a microphone, a speaker, and other electronic components. In addition, the portable electronic device includes structural elements such as a housing having an outer shell. In some embodiments, the outer shell is comprised of one or more layers bonded together. Each layer may be of any suitable form and provide any suitable function. For example, a layer may be a protective top coating. In another example, a layer may be a “functional” layer with integrated circuits and sensors. Also, layers may be of any suitable material.

User 40 refers to an individual or group of individuals that is capable of using the design site 24 to supply or create a graphics image and/or order the personalized portable electronic device.

A client computer 30 refers to any suitable device that is capable of allowing user 40 to display design site 24 on a web browser, accept input from user 40, and communicate with server computer 22 on design module 20. Some examples of suitable devices include a desktop computer, a laptop computer, a cellular or mobile phone, a personal digital assistant (PDA), or the like.

Design module 20 refers to any suitable combination of hardware and software that provide applications and services on design site 24 and make design site 24 accessible to user 40. Design module 20 includes a server computer 22. “Server” or “server computer” typically refers to a powerful computer or cluster of computers. For example, the server computer can be a large mainframe, a minicomputer cluster, or a group of servers functioning as a unit. In one example, the server computer may be a database server coupled to a Web server (not shown). Design module 20 may use any suitable network, including the Internet, to communicate with printer module 50 and/or user 40 through client computer 30. Server computer 22 may also include a computer readable medium and a processor. The computer readable medium comprises code for performing the functions of server computer 22 and the processor performs the functions using the code.

Server computer 22 provides design site 24 on a web browser on client computer 30. Design site 24 is comprised of a plurality of interrelated web pages and related content such as images, videos, and applications that can be accessed and displayed on client computer 30 using a web browser.

Design site 24 includes a series of webpages and other content that allow user 40 to perform suitable tasks to create a personalized portable electronic device. Some examples of suitable tasks include determining a graphics image, modifying a graphics image, previewing a personalized portable electronic device, ordering a personalized portable electronic device, and/or allowing the user 40 to display their graphics image on design site 24 so that other users can use the image. Design site 24 is organized to provide tools that allow user 40 to perform certain tasks. The illustrated embodiment of design site 24 shows tools including a design generator 26, composer 27, and previewer 28. In another embodiment, design site 24 may include other tools such as a shopkeeper tool that allows user 40 to choose to become a “shopkeeper” on design site 24 and set up a “shop” with products having one or more graphics images provided by user 40.

In determining a graphics image, user 40 can upload a customized graphics image, generate a new customized graphics image, or select a predefined graphics image from a library of predefined graphics images. Any of the graphics images can be modified after uploading/selection by the user. The library of predefined graphics images refers to a listing of predefined graphics images. The predefined images listed in the library may be provided by any suitable source. Some examples of suitable sources include vendors, user 40, other users, and other entities in system 10. In one example, other users may provide their customized graphics images to be listed in the library. As another example, a vendor such as a professional sports team may provide their predefined images to the library for a fee.

The library of predefined graphics images may include a description associated with each predefined graphics image. The description may include information such as a title of the graphics image, the source of the graphics image, the date that the graphics image was created, the number of times that the image has been placed on a product by users, and other suitable information. For example, an image description may indicate “by John Doe.”

User 40 can use the design generator 26 on design site 24 to generate a new customized graphics image. Design generator 26 refers to a series of webpages and other content of design site 24 that can be used to create graphics images using parameters defined by user 40. Design generator 26 takes these user-defined parameters and a random generator application to generate a plurality of graphics images and animate the images. Any suitable parameters for creating a graphics image can be used. Some examples of suitable parameters include a selection of one or more colors, a pattern, and a position on a slider bar that defines the intensity of how the animation will adapt itself from the originally selected parameters. Design generator 26 displays an animation of the graphics images generated. In some cases, user 40 can take a snapshot of the animation to create their customized graphics image for their personalized portable consumer device. Examples of design generator 26 can be found in U.S. patent application Ser. No. ______, filed Sep. 19, 2008, entitled “Design Generator for Personalization of Electronic Devices” (Attorney Docket No. 027643-002200US) and U.S. patent application Ser. No. ______, filed Sep. 19, 2008, entitled “Method of Operating a Design Generator for Personalization of Electronic Devices” (Attorney Docket No. 027643-002300US).

In one embodiment, user 40 may use design module 20 to combine two images to form a combination image. For example, user 40 may create a first image using design generator and upload a second image from client computer 30. User 40 may use design module 20 to overlay the second image (e.g., a family photograph) on top of the first image (e.g., a yellow orange polka dot pattern) to make a combination image.

In the illustrated embodiment, user 40 can use the composer 27 on design site 24 to modify the graphics image determined by user 40. Composer 27 refers to one or more webpages and other content of design site 24 that allow the user 40 to position, scale, and/or rotate a graphics image and dynamically display these modifications relative to a stationary image of the portable electronic device. Using the positioning function of composer 27, user 40 can move the graphics image to a different position on the stationary image of the portable electronic device. The scaling function allows the user 40 to shrink and expand the graphics image. Using the rotating function, the user 40 can rotate the graphics image relative to the stationary image of the portable electronic device.

User 40 can use the previewer 28 to preview the personalized portable electronic device. Previewer 28 refers to one or more webpages and other content of design site 24 that allow the user 40 to preview a rendered image of the personalized portable consumer device. In some cases, previewer 28 may allow user 40 to rotate the rendered image to view the personalized portable electronic device from various angles. In other cases, previewer 28 will provide multiple thumbnail views that user 40 can select. When user 40 selects a thumbnail view, previewer 28 displays a rendered image of the personalized portable electronic device at a preset angle associated with the view selected.

In some embodiments, previewer 28 dynamically updates the rendered image of the personalized portable electronic device as user 40 generates the graphics image using design generator 26 and/or modifies the graphics image using composer 27. For example, previewer 28 may be displayed along with composer 27. As user 40 modifies the graphics image using composer 27, the rendered image of the personalized portable electronic device on previewer 29 may be dynamically updated to reflect the changes made using composer 27. As another example, previewer 28 and design generator 26 may both be displayed. As user 40 creates a graphics image using design generator 26, the rendered image of the personalized portable electronic device on previewer 29 may be dynamically updated to reflect the newly created graphics image. In some cases, previewer 28 may display a rendered image of the personalized portable electronic device with the animated graphics images created using design generator 26. User 40 could then select a snapshot image of the animation on design generator 26 while viewing the rendered image on previewer 28.

Design site 24 also allows user 40 to place an order for the personalized portable electronic device with their graphics image. The order includes any suitable order information required to complete the order such as the graphics image, the type of portable electronic device being ordered, the number of devices being ordered, the shipping address, payment method, the payment information, and other suitable information.

In some embodiments, design module 20 modifies the graphics image determined by the user 40. In one embodiment, design module 20 masks the graphics image. Masking refers to modifying the graphics image to include one or more cutout areas. For example, design module 20 may determine that there is a lens on the portable electronic device (e.g., a camcorder). Design module 20 may determine that the graphics image needs to be masked around the lens to avoid blocking the lens with the graphics image. Accordingly, design module 20 defines a circular cutout around the lens and modifies the graphics image to include the cutout area. As a result, the modified graphics image includes a cutout around the lens. As another example, design module 20 may determine that a product logo may be located on a portion of the portable electronic device that has been personalized with a graphics image. Design module 20 may define a cutout area around the product logo and modify the graphics image to include the cutout around the product logo. In another embodiment, design module 20 may modify the graphics image to include images such as a product logo, demarcating lines, or other suitable images. In some cases, design module 20 may modify the graphics image based on the user input into design site 24. For example, design module 20 can modify graphics image to include a product logo using one of the colors used to generate the graphics image. In these embodiments, previewer 28 and composer 27 may use the graphics image determined by user 40 and modified by design module 20.

Printer module 50 refers to any suitable combination of hardware and software that provide services for receiving an order from server computer 22 and for managing the fulfillment of the order. Fulfilling an order generally refers to the steps of completing the order. Such steps include permanently affixing the graphics image to a portable electronic device received from manufacturing module 60. Printer module 50 may use any suitable network, including the Internet, for communicating with other modules.

Printer module 50 includes a server computer 52. Server computer 52 may include a computer readable medium and a processor. The computer readable medium comprises code for performing the functions of server computer 52 and the processor performs those functions using the code. Printer module 50 also includes a design database 56 and a user profile database 57, in communication with server computer 52. In other embodiments, printer module 50 may not have a design database 56 and user profile database 57 or the databases may be on another component of system 10. In the illustrated embodiment, server computer 52 manages the data stored on design database 56 and user profile database 57.

Design database 56 may include any hardware, software, firmware, or combination of the preceding for storing and facilitating retrieval of information related to the graphics images uploaded to, generated on, and/or provided on design site 24. Such information includes the graphics images in the form of digital files. The digital files may be in any suitable format such as a PDF format, jpeg format, gif format, or other suitable format. Design database 56 may use any of a variety of data structures, arrangements, and compilations to store and facilitate retrieval of this information. In the illustrated embodiment, design database 56 is located in printer module 50. Design database 56 may be located on other components of system 10 in other embodiments. For example, design database 56 may be located on design module 20.

Likewise, user profile database 57 may include any hardware, software, firmware, or combination of the preceding for storing and facilitating retrieval of profiles associated with users 40 accessing design site 24. Similarly, user profile database 57 may use any of a variety of data structures, arrangements, and compilations to store and facilitate retrieval of this information. In the illustrated embodiment, user profile database 57 is located in printer module 50. User profile database 57 may be located on other components of system 10 in other embodiments. For example, user profile database 57 may be located on design module 20. In another example, user profile database 57 may be located on a server available over the network.

User profile database 57 can store any suitable data related to the users. Some examples of suitable data include user information such as contact information and billing information, sharing information, and shopkeeper data. Shopkeeper data refers to any suitable data associated with the sale of products having the graphics image provided or created by user 40.

Shopkeeper data may include parameters entered by the user 40 on design site 24 that define the way in which products with the user's image will be sold on design site 24. Some examples of such parameters include an indication that user 40 wants to be a shopkeeper, a list of the one or more graphics images, a selection of users that they want to sell to, and the types of products that will be on sale. Shopkeeper data may also include the information associated with the values that will be given to user for the sale of products parameters entered by the user 40 on design site 24. Some examples of such data include the predefined percentage of the profits that will be given to user 40, the total number of products sold with the user's image, the profits earned by the sale of those products with the user's graphics image, the value given to the user 40 for the sale of the product, and/or other suitable data.

Sharing information refers to any suitable data associated with the sharing of the user's graphics image with other users without receiving any profits from the sale of products having the graphics image. For example, sharing information may include the user names of the users that user 40 chooses to share their graphics image with. In one case, user 40 may choose to share their graphics image with a group of family members. In another case, user 40 may choose to share their image with all users so that their graphics image is widely available for any user on the design site 40.

Printer module 50 also includes a printer 58 for permanently affixing the graphics images to the outside surface of a sealed housing of finished portable electronic devices received from manufacturing module 60. “Permanently affixing” refers to applying the graphics image onto the finished portable electronic device so that it cannot be removed by the consumer 40. A sealed housing refers to a housing that has been sealed by the manufacturing module 60 so that it is not intended to be removed or easily removable by the user 40. For example, a sealed housing may not have fasteners (e.g., screws) visible and/or accessible by the user 40 to remove the housing. Also, the seams of the sealed housing tightly fit together to minimize gaps which makes it difficult for the user 40 to remove the housing. The manufacturing module 60 seals the housing after the portable electronic device has been assembled and thus the functioning electronics are located within the sealed housing.

Printer 58 uses specialized processes to permanently affix the graphics image onto the sealed housing to prevent damaging the functioning electronics inside. Such processes must also be capable of printing on portable electronic devices with three dimensional curved surfaces. Suitable processes include certain ink-jet printing processes, dye sublimation, and silk screening. One such process is performed by a high-speed digital ink-jet printer that is customized to print on three-dimensional curved surfaces. An example of such a printer is a Mimaki™ UJF 605CII printer. The process uses a non-contact printing method. A non-contact printing method refers to a method of printing where the print head of the printer does not contact the device being printed upon. For this reason, the printer can print graphics images onto the surfaces having complex surface curvature. Since this is a non-contact printing method, the process has better results on complex curvature than contact printing such as screen printing and pad printing. In this process, ink or other chemicals are provided onto the surface of the portable electronic device. An advantage of the ink-jet process over previous etching processes is that material is not removed from the surface of the portable electronic device during this process. This prevents possible damage to the surface layer. In some cases, portable electronic devices could have a functional surface layer that could be damaged by etching processes. Also, this process does not require high temperature processing so that the electronics sealed inside the portable electronic device will not be damaged. Further, this process prints with high resolution so that graphics images are vividly portrayed.

In one embodiment, printer module 50 fades the graphics image around the edges of the portable electronic device. “Fading” refers to reducing the intensity or brightness of the graphics image. In some cases, fading reduces the intensity of the graphics image according to an exponential function. For example, the graphics image can be at full intensity at the beginning of the edge and reduce in an exponential fashion to zero at the end of the edge. In other cases, fading reduces the intensity of the graphics image according to a linear function. Fading can be accomplished using any suitable method. For example, the graphics image can be altered digitally using software code. As another example, the printer 58 can include a physical obstruction (e.g., a screen) that provides for fading the graphics image.

In a typical process, user 40 determines a graphics image on design site 24 that will be used to personalize their portable electronic device. First, user 40 either uploads a customized graphics image, selects a predefined graphics image displayed on design site 24, or generates a new customized graphics image using design generator 26. If user 40 uploaded or generated the customized graphics image, user 40 can modify the graphics image using composer 27 to rotate, scale, and/or or position the graphics image onto an image of the portable electronic device. Using previewer 28, user 40 previews a rendered image of the personalized portable electronic device with the graphics image. As discussed previously, the previewer is generally viewable at same time that the user 40 is using the composer. Thus, the previewer is not just limited to previewing final image. Next, user 40 places an order for the personalized portable electronic device. User 40 can also choose to share their graphics image with other users of design site 24 or become a shopkeeper getting a portion of the profits on subsequent sales of products having their graphics image.

On the back end, server computer 22 processes the order and sends the order with the graphics image to server computer 52. Server computer 52 stores the graphics image on design database 56 and forwards the graphics image to printer 58. Printer 58 prints the graphics image onto a finished portable electronic device received from manufacturing module 60. Printer 58 sends the personalized portable electronic device to shipping module 80. Shipping module 80 delivers the personalized portable electronic device to the user 40.

### A. Shopkeeper

In one embodiment, user 40 can be become a “shopkeeper” on design site 24. That is, user 40 provides a graphics image for their “shop” and receives a portion of the profits for subsequent sales of products having their graphics image. User 40 may provide a graphics image that they created using design generator 26 or upload a graphics image. User 40 has the option of selecting the products that they want to sell in their “shop.” In becoming a “shopkeeper,” user may receive a portion of the profits from sales without having to provide upfront costs or inventory. In addition, design module 20 and printer module 50 promote the products, produce the personalized products, process the transactions, fulfill the orders, manage the returns/exchanges, offer customer service, and send a percentage of the profits for the sales on the design site 24 back to user 40.

Other users access user's “shop” on design site 24. In other embodiments, other users can access user's “shop” on a printer site provided by server computer 52. In some cases, the printer site can also be a remote site that communicates with design site 24 and other users can access the printer site through the design site 24.

User 40 may also have the option of selecting a group of users that they want to sell products to. For example, user 40 may want to set up a “shop” for products having family photos. User 40 may set up a group of users including only family members so that only the family members have access to the photos and products with the photos.

The parameters used to define the “shop” are communicated to server computer 52 and stored on user profile database 57 as shopkeeper data. Before the graphics image provided by user 40 is displayed on design site 24 in the “shop”, the graphics image can be screened for appropriate content. Once screened, the graphics image is displayed on design site 24 as a predefined image in user's “shop”.

When a product is sold, server computer 52 determines the value of the portion of profits due to the user 40 based on the predefined percentage of profits and the profits from the sale. Server computer 52 will disburse the value at any suitable time. Some examples of suitable times for disbursement include each time a product is sold, when the value due user 40 reaches a predetermined value (e.g., $100), when user 40 requests disbursement, or on a periodic basis (e.g., monthly). The value due to user 40 may be disbursed using any suitable form of payment. In one case, the value will be disbursed in a negotiable form such as a check. In another case, user 40 may receive the value in the form of a credit to purchase other products on design site 24. These credits may be based on a point system, for example, where user 40 receives a portable electronic device if N (e.g., 10) products are sold. In yet another case, user 40 may gift the value to other users. User 40 may be given the option of one of these forms of payment. The value of profits due to user 40 are stored on user profile database 57.

### B. Sharing

In another embodiment, user 40 may select to share their graphics image with other users. “Share” or “sharing” refers to providing the graphics image to other users without receiving a portion of the profits from the subsequent sales i.e. user 40 receives a zero portion of the profits. For example, user 40 may select a group of users on design site 24 that can purchase products with the user's graphics image without the user 40 getting any profits. As another example, user 40 may share their graphics image with all users. In this way, user 40 can exhibit the graphics image that they created on a website for others to view and potential use on products. Before the graphics image provided by user 40 is displayed on design site 24, the graphics image can be screened for appropriate content. Once screened, the graphics image is displayed as a predefined graphics image on design site 24. In some cases, user 40 may become a “shopkeeper” on design site 24 as described above to set up a “shop” and receive a zero portion of the profits for the sales of products having their graphics image. In these cases, the graphics image is displayed on design site 24 as a predefined image in user's “shop”.

In the embodiments described in the shopkeeper and sharing sections, user 40 is given an opportunity to display their creativity in the form of a graphics image on a public website for others to view. If user 40 becomes a “shopkeeper,” user 40 may also receive the added benefit of receiving a portion of the profits from sales of products with their graphics image. When user 40 chooses to become a “shopkeeper” or share their graphics image, user 40 assigns all rights in the graphics image to the owner of design site 24. Design site 24 may provide an agreement that user 40 must accept to be able to have the option of “sharing” and/or becoming a “shopkeeper.”

Modifications, additions, or omissions may be made to system 10 without departing from the scope of the disclosure. Also, the components of system 10 may be integrated or separated according to particular needs. For example, although design module 20 and printer module 50 are described as separate entities in some embodiments, design module 20 and printer module 50 can be the same entity in other embodiments. As another example, although printer module 50 and manufacturing module 60 are described as separate entities in the some embodiments, printer module 50 and manufacturing module 60 can be the same entity in other embodiments. Moreover, the operations of system 10 may be performed by more, fewer, or other system components. In other embodiments, printer module 50, or any component thereof (e.g., printer 58), may be a component of manufacturing module 60 or design module 20. Additionally, operations of system 10 may be performed using any suitable logic comprising software, hardware, other logic, or any suitable combination of the preceding.

### II. Exemplary Method of Personalizing a Portable Electronic Device

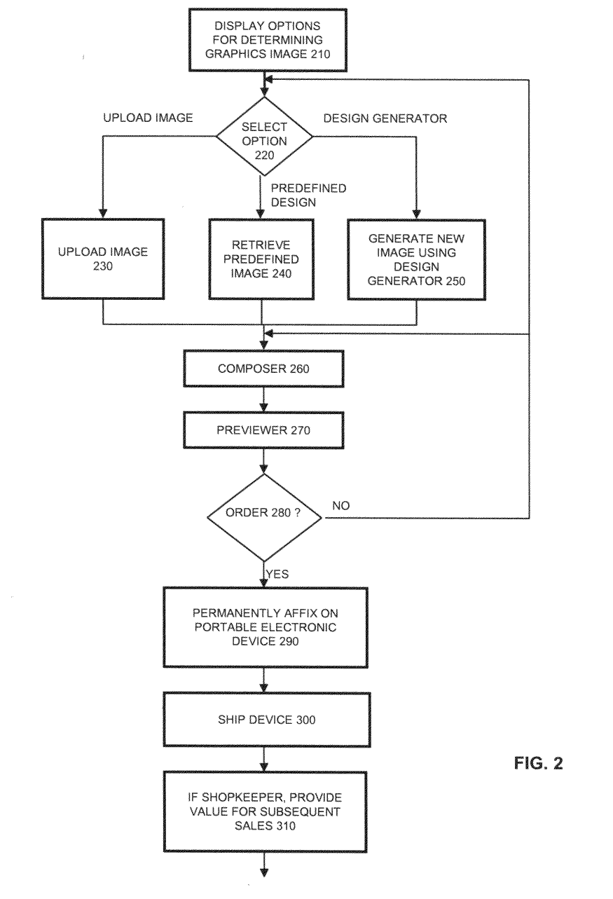

FIG. 2 is a flowchart illustrating a method of personalizing a portable electronic device, in accordance with an embodiment of the disclosure. The method begins by server computer 22 providing options on design site 24 for determining a graphics image to be placed on a personalized portable electronic device (step 210). Exemplary options include uploading a graphics image, selecting a predefined graphics image, and using design generator 26 to create a new graphics image. User 40 selects one of the options (step 220).

If the user 40 selects the option of uploading an image, server computer 22 complies by providing one or more options for selecting an image to upload. For example, user 40 may be provided with a browse option for searching through file directories and selecting a file to upload. Server computer 22 uploads the selected image (step 230).

If the user 40 selects the option of selecting a predefined graphics image, server computer 22 complies by providing one or more webpages that allow user 40 to select a graphics image from a library of predefined graphics images. In some cases, the graphics image and a description of the graphics image are displayed. User 40 selects an image from the library of predefined graphics images. Server computer 22 sends a request message to server computer 52 to retrieve the image from design database 56. The server computer 52 retrieves the image from design database 56 and sends the image to server computer 22 (step 240).

In another embodiment, the library of predefined graphics images may also include a virtual “shop” associated with another user. The “shop” includes products on sale with graphics images provided by the other user. In some cases, the other user selected user 40 as one of a group of users that have access to the “shop.”

If the user 40 selects the option of using design generator 26, server computer 22 complies by providing the design generator 26 on design site 24. User 40 defines various parameters on design generator 26 that will be used to generate the graphics images. In one example, user 40 selects two colors, a type of pattern (e.g., dots), a pattern within the type of pattern (e.g., random), and a position on a slider bar that defines the intensity of how the animation will adapt itself from the originally selected parameters. Once user 40 enters the parameters, server computer 22 generates graphics images and animates the graphics images. User 40 selects a graphics image from the animation on design generator 26 as their new image (step 250). For example, user 40 may select a “position and preview” button that takes a snapshot image of the animation. The image is copied from the design generator 26 to the composer 27.

User input refers to any selections made on design site 24 by user 40, any data input into design site 24, or any data derived from such selections or data input. For example, user input includes the user-defined parameters entered into design generator 26 by user 40.

In response to the selection of user 40 of the graphics image, server computer 22 displays composer 27 on design site 24. The graphics image displayed in composer 27 may be a single image or a series of tiled images. User 40 can use composer 27 to compose (e.g., modify) the graphics image chosen by user 40 based on input from user 40 (step 260). User 40 can provide input into composer 27 to rotate, scale, or position the graphics image. Server computer 22 displays the modified image onto a image of the portable electronic device. For example, user 40 may input a new scale value such as 0.5 or change the scale of the image by dragging the cursor across the screen. In response, server computer 22 would display on design site 24 a image of the portable electronic device with the scaled image. As another example, user 40 can position the graphics image by selecting the graphics image and placing it in a new position on the image.

Server computer 22 displays previewer 28 on design site 24. User 40 uses previewer 28 to preview a rendered image of the personalized portable electronic device having the graphics image (step 270). If user 40 modified the graphics image using composer 26, the rendered image of the personalized portable electronic device will include the graphics image as modified using composer 26. In some cases, user 40 may use previewer 28 to rotate the rendered image to view all sides of the rendering. Thus, embodiments of the present invention provide for a number of options for the user, including predefined views of the personalized portable electronic device, thumbnails of the device at various stages of the design process, and real time updating of the images of the device that are displayed to the user. Additionally, some embodiments, enable the previewer and the composer to share a window or to open an alternate window that is visible at the same time as composer. One of ordinary skill in the art would recognize many variations, modifications, and alternatives.

Server computer 22 gives user 40 the option of ordering the personalized portable electronic device as rendered in the previewer (step 280). If user 40 does not want to place an order for the device as rendered in the previewer 28, server computer 22 displays the options: determining another graphics image (step 210) or modifying the graphics image in another way (step 260).

If user 40 chooses to place an order for the personalized portable electronic device (step 280), server computer 22 requests order information from user 40 on design site 24. For example, server computer 22 may request order information such as a shipping address, billing address, payment method, payment device information, and other suitable information. Server computer 22 processes the order. In other embodiments, server computer 22 may forward the order to server computer 52 for processing.

Once personalized portable electronic device is ordered, server computer 22 sends the order with the graphics image to server computer 52. Server computer 52 forwards the graphics image to printer 58. Printer 58 permanently affixes the graphics image to an outside surface of the top layer of the sealed housing of the finished portable electronic device received from manufacturing module 60 (step 290).

In another embodiment, the graphics image is permanently affixed to an inside layer of the sealed housing. In this embodiment, the layers on top of the printed inner layer are transparent, partially transparent, or translucent so that the graphics images are visible. The graphics image is typically affixed to the inner layer during the manufacturing process at manufacturing module 60. For example, a printer (not shown) at manufacturing module 60 would print the graphics image to an inside layer and then bond one or more layers on top of the printed layer.

After the portable electronic device is personalized with the graphics image, the device is sent to a shipping module 80. Server computer 52 forwards at least a portion of the order to shipping module 80. Shipping module 80 ships the personalized portable electronic device to user 40 (step 300).

If user 40 is a “shopkeeper” on design site 24, server computer 52 will disburse a value for subsequent sales to user 40 (step 310). The value refers to a portion of the profits for subsequent sales of products having user's graphics image. Server computer 52 determines the value based on a predefined percentage of profits and the profits determined from the subsequent sales. Server computer 52 disburses the value at any suitable time. For example, server computer 52 can disburse the value on a periodic basis (e.g., monthly). The value may be disbursed to user 40 using any suitable form of payment such as a check.

In one embodiment, the graphics image is affixed to the portable electronic device after the initial shipment to the user 40. In this embodiment, a user 40 receives the initial shipment of a portable electronic device and sends it back for personalization to the shipping module 80 or the printer module 50. User 40 determines the graphics image and orders a personalization of the portable electronic device. After the graphics image is permanently affixed to the portable electronic device, the personalized portable electronic device is shipped to the user 40.

Modifications, additions, or omissions may be made to the method without departing from the scope of the disclosure. The method may include more, fewer, or other steps. Additionally, steps may be performed in any suitable order without departing from the scope of the disclosure.

### III. Webpages on an Exemplary Design Site

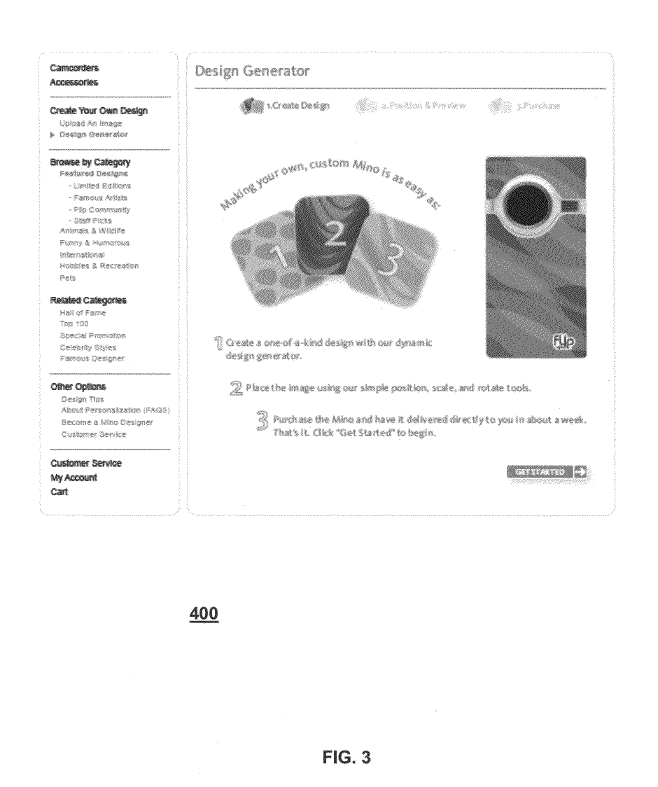

FIGS. 3-6 are screen shots of webpages of an exemplary design site 24, in accordance with embodiments of the disclosure. The screenshots were taken from an exemplary design site 24.

FIG. 3 shows a webpage 400 on design site 24 that allows a user 40 to start the process of using a design generator 26 to generate a graphics image. Webpage 400 describes the steps in the process. In the illustrated embodiment, the first step is to “create a one-of-a-kind design with our dynamic design generator.” The second step is to “place the image using our simple position, scale, and rotate tools.” The third step is to “purchase the Mino and have it delivered directly to you in about a week.”

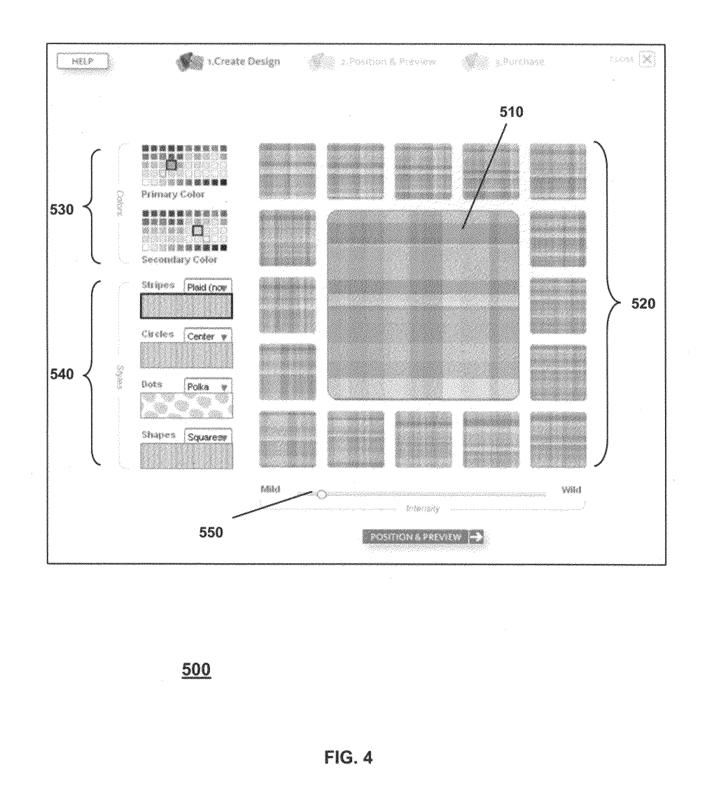

FIG. 4 shows a webpage 500 that allows a user 40 to enter user-defined parameters into a design generator 26 to generate a graphics image. Webpage 500 includes a center display 510 that is animated and sixteen tile displays 520 around the center display 510. Pausing the animation populates the sixteen tile displays 520. Webpage 500 also includes two color grids 520 where user 40 can select a primary color and a secondary color. Webpage 500 also includes four pull down style menus 540 where user 40 can select a pattern. Webpage 500 also includes an intensity slider that allows user 40 to control an intensity value. The intensity value determines the extent to which the animation will adapt from the original parameters.

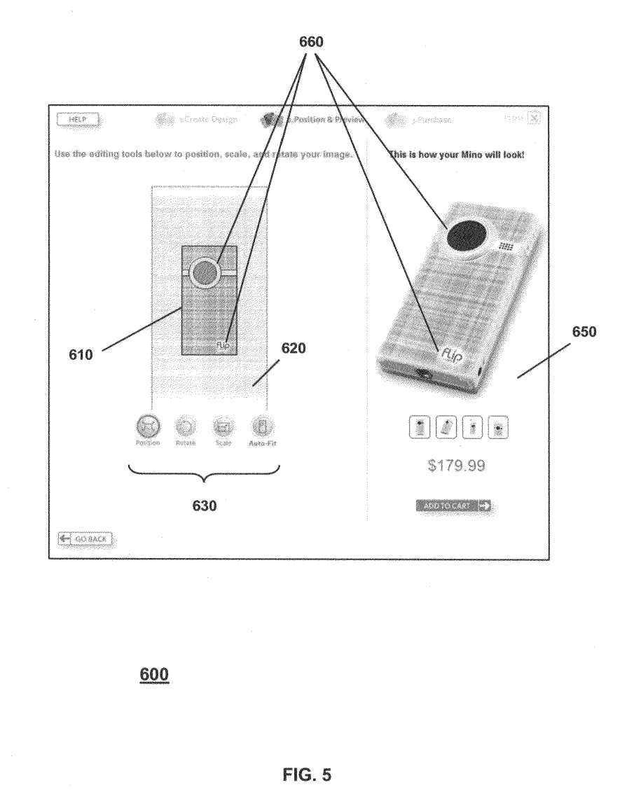

FIG. 5 shows a webpage 600 that allows a user 40 to enter information to modify (position, scale, and/or rotate) their graphics image using a composer 27. As discussed previously, the graphics image can be created using the design generator described herein, uploaded by a user, selected from stock images, or uploaded/selected and then modified. Webpage 600 includes a first image 610 of the portable electronic device and a image 620 of the graphics image as modified overlaying the first image 610. User 40 selects buttons 630 to choose to position, scale, or rotate the graphics image. As the user manipulates the graphics image, the previewer displays the graphics image in real time on an exemplary personalized portable electronic device. Thus, changes made by the user can be previewed in real time, enabling the user a high level of control over the finished graphics image.

Webpage 600 also allows user 40 to enter information to preview their personalized portable electronic device using previewer 28. Webpage 600 includes a rendered image 650 of the personalized portable electronic device. In this embodiment, previewer 28 dynamically updates the rendered image of the personalized portable electronic device as the graphics image is modified by user 40 using composer 27.

In some embodiments, design module 20 masks the graphics image which modifies it to include one or more cutout areas. Previewer 28 and composer 27 may display the graphics image with the cutout areas. In the illustrated embodiment, design module 20 has masked the graphics image around the lenses and logos on the portable electronic device. Webpage 400 displays the graphics image with four cutout areas 660 around the lenses and logos.

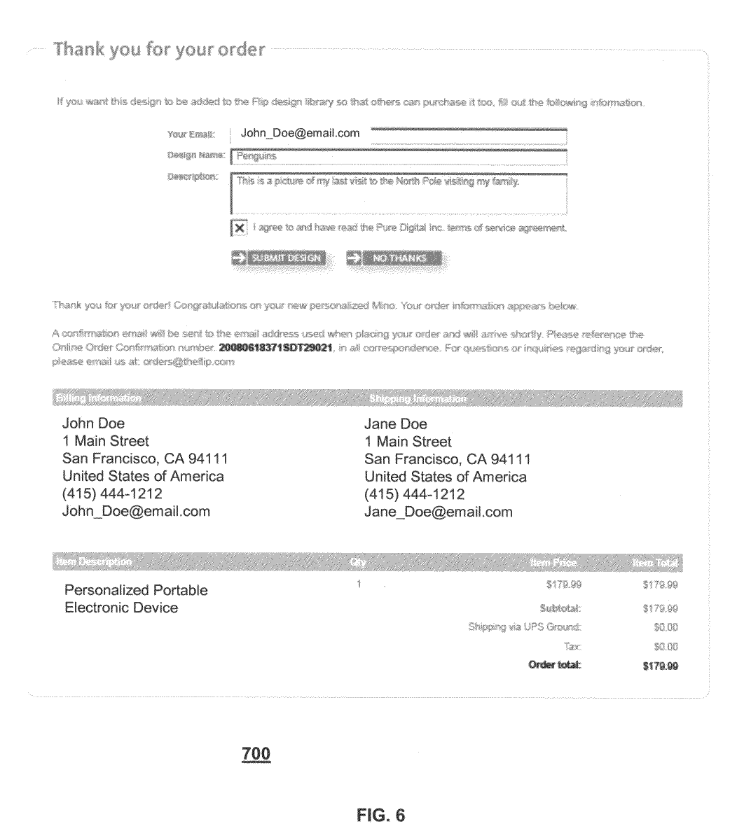

FIG. 6 shows a webpage 700 that allows a user 40 to have their design added to the library of predefined graphics images after the order is placed by user 40. In some embodiments, user 40 may be a “shopkeeper” and receive a portion of the profits earned from the purchase of products having user's image. In other embodiments, user 40 may “share” their images with others without receiving profits from sales of products.

It should be understood that the present disclosure as described above can be implemented in the form of control logic using computer software in a modular or integrated manner. Based on the disclosure and teachings provided herein, a person of ordinary skill in the art will know and appreciate other ways and/or methods to implement the present disclosure using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

A recitation of “a”, “an” or “the” is intended to mean “one or more” unless specifically indicated to the contrary.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more features from any embodiment may be combined with one or more features of any other embodiment without departing from the scope of the disclosure.

All patents, patent applications, publications, and descriptions mentioned above are incorporated herein by reference in their entirety for all purposes. None is admitted to be prior art.

What is claimed is:

1. A method of personalizing a portable electronic device, comprising:
determining a customized graphics image based on user input; and
providing for permanently affixing the customized graphics image to the portable electronic device.

2. The method of claim 1 further comprising providing for disbursing a value to a user for each subsequent sale of a product having the customized graphics image.

3. The method of claim 1 further comprising enabling the user to share the customized graphics image with other users.

4. The method of claim 1 further comprising providing for shipping the portable electronic device having the customized graphics image to a user.

5. The method of claim 1 further comprising providing the customized graphics image to one or more other users.

6. The method of claim 1 further comprising previewing a rendering of the portable electronic device having the customized graphics image.

7. The method of claim 6 wherein the rendering is dynamically updated.

8. The method of claim 1 further comprising masking the customized graphics image to include a cutout.

9. The method of claim 8 wherein the cutout is associated with a location of a logo on the portable electronic device.

10. The method of claim 1 wherein the customized graphics image is printed to an outer surface of a sealed housing of the portable electronic device.

11. The method of claim 1 wherein the customized graphics image is printed to an inner layer of a sealed housing of the portable electronic device.

12. The method of claim 1 wherein providing for permanently affixing the customized graphics image to the portable electronic device comprises communicating the customized graphics image to a printer module, wherein the printer module permanently affixes the customized graphics image to the portable electronic device.

13. The method of claim 1 wherein determining a customized graphics image based on user input comprises uploading the customized graphics image.

14. The method of claim 1 wherein determining a graphics image based on user input comprises generating the customized graphics image using a design generator.

15. The method of claim 14 wherein the design generator uses a random generator.

16. The method of claim 1 wherein determining a customized graphics image based on user input comprises fading the customized graphics image over one or more edges of the portable electronic device.

17. The method of claim 16 further comprising masking a portion of the customized graphics image.

18. The method of claim 1 wherein determining a customized graphics image based on user input comprises at least one of rotating, scaling, or positioning the customized graphics image.

19. The method of claim 1 further comprising:
providing a first portion of a display that allows the user to enter modifying input to modify the customized graphics image; and
providing on a second portion of a display a rendering of the portable electronic device having the modified customized graphics image, wherein the rendering is dynamically updated based on the modifying input entered by the user on the first portion of the display.

20. The method of claim 1 further comprising downloading the customized graphics image to a client computer.

21. A system for personalizing a portable electronic device, the system comprising:
a client computer; and
a server computer in communication with the client computer, the server computer having a computer readable medium comprising:
code for determining a customized graphics image based on user input entered on the client computer; and
code for providing for permanently affixing the customized graphics image to the portable electronic device.

22. The system of claim 21 further comprising a design database in communication with the server computer, wherein the server computer further comprises code for storing the customized graphics image to the design database.

23. A personalized portable electronic device, comprising:
a processor;
a rechargeable power supply communicating with the processor;
a memory communicating with the processor; and
a housing having an outer shell, wherein the housing is sealed around the processor, rechargeable power supply and the memory, wherein a customized graphics image determined by a user is permanently affixed to the outer shell after the housing is sealed.

24. A method of personalizing a finished portable electronic device, the method comprising:
generating a customized graphics image using a design generator based on user input; and
providing for permanently affixing the customized graphics image on a sealed housing of the finished portable electronic device.

25. The method of claim 24 further comprising providing for disbursing a value to a user for each subsequent sale of a product having the customized graphics image.

26. A method of personalizing a finished portable electronic device, comprising:
determining a customized graphics image based on user input; and
permanently affixing the customized graphics image to the finished portable electronic device.

27. The method of claim 26 further comprising providing a value to a user for each subsequent sale of a product having the graphics image.

28. The method of claim 26 further comprising allowing the user to share the customized graphics image with other users.

29. A method of personalizing a finished portable electronic device, the method comprising:
providing an option of using a design generator to determine a customized graphics image;
if a user selects the option of using the design generator, determining the customized graphics image using the design generator based on input from the user; and
sending the customized graphics image to a printer, wherein the printer permanently affixes the customized graphics image onto the finished portable electronic device.

30. The method of claim 29 further comprising providing a value to the user for each subsequent sale of a product having the graphics image.

31. The method of claim 29 further comprising allowing the user to share the customized graphics image with other users.
